(19) United States
(12) Patent Application Publication
(10) Pub. No.: US 2005/0188301 A1
(43) Pub. Date: Aug. 25, 2005

(54) Method for providing data for a sheet, in particular for creating a print, and sheet provided thereby

(75) Inventor: Frank Gnutzmann, Gettorf (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/029,551

(22) Filed: Jan. 5, 2005

(30) Foreign Application Priority Data
Feb. 6, 2004 (DE) 10 2004 005 821.0

(51) Int. Cl. G06F 17/00; G06F 17/21; G06F 15/00; G06F 17/24

(52) U.S. Cl. 715/515; 715/530; 715/517; 715/911

(57) ABSTRACT

A method for providing data for a sheet formed of at least two pages (content pages) within a workflow, in particular for creating a print, uses a data-processing device that contains at least one data storage device, a data input device and a monitor. A sheet is provided in the data storage medium, preferably a data storage medium implemented in a data-processing device, and contains the plurality of pages (content pages), preferably following an imposition scheme. The object is to form the creation of the content of a sheet such that it can be influenced (edited) for as long as possible. The content of each of the pages of the sheet is provided such that the respective page is provided in relation to a possible change and/or replacement and a changed or replacement page is then inserted into the sheet as a replacement.

### BACKGROUND OF THE INVENTION

Field of the Invention

The invention relates to a method for providing the data for a sheet containing at least two pages (content pages) within a workflow, in particular for creating a print, by using a data-processing device which contains at least one data storage device, a data input device and a monitor.

Furthermore, the invention relates to a sheet provided in a data storage medium, preferably a data storage medium implemented in a data-processing device, in particular for the creation of a print, which contains a plurality of pages (content pages), preferably following an imposition scheme.

An apparatus and a method for the digital imposition of a sheet which contains a plurality of pages, for the purpose of imaging a printing plate, is disclosed by U.S. Pat. No. 6,384,932, for example. For this purpose, with the aid of a data-processing device which contains a data storage device, a data input device and a monitor, data for the pages is produced, the pages are then disposed and positioned for the purpose of imaging the printing plate in relation to a printed sheet and the printed image is then scanned. If a change has to be made in one of the pages or one page in the printed sheet has to be replaced, then the entire operation must be carried out once more.

If, from the start, account is taken or provision is made to accommodate variable, interchangeable data in individual pages, then the fixed, continually repeating data and the variable data are brought together when creating the page before imposition is carried out, as can be gathered, for example, from U.S. Pat. No. 6,332,149. However, if a page has to be replaced or corrected, then the entire operation also has to be repeated once more.

### SUMMARY OF THE INVENTION

It is accordingly an object of the invention to provide a method for providing data for a sheet, in particular for creating a print, and a sheet provided thereby which overcomes the above-mentioned disadvantages of the prior art methods and devices of this general type, in which a content of the sheet can be influenced for as long as possible.

With the foregoing and other objects in view there is provided, in accordance with the invention, a method for providing data for a sheet containing at least two pages within a workflow. The method includes the steps of providing and using a data-processing device containing at least one data storage device, a data input device and a monitor; and providing each of the pages such that each of the pages can be edited.

According to the invention, from the point of view of the method, the object is achieved in that each page is provided such that it can be edited. For this purpose, the content of each of the pages of the sheet is preferably provided in such a way that the respective page is provided in relation to a possible change and/or replacement and a changed or replacement page is then inserted into the sheet as a replacement.

In particular, therefore, at any time a change of a page or of a page content is advantageously possible in the course of the sheet creation, above all in the course of imposition, without the entire sequence having to be broken off and carried out completely again.

In recent times, during the creation of a sheet, use is frequently made of what is known as the “Portable Document Format” (PDF), which is well known and above all widespread in office applications, while in professional printing, PostScript has otherwise normally been used. In this way, better compatibility between professional printing and what is known as desktop publishing is achieved. Both POSTSCRIPT and PDF are developments and designations of ADOBE, from Adobe Systems, Inc. of Mountain View, Calif., USA.

“Portable Document Format” (PDF), as it is known, is a digital format which reproduces the visual appearance of documents electronically, it being possible for these documents originally to be produced in this format or to be converted into this format from other electronic formats or digitized from an original, for example from paper, in particular by using a scanner. A method and a device for viewing electronic documents of this type are known, for example, from U.S. Pat. No. 5,634,064.

According to a development of the invention, in order to achieve the object for a sheet to be produced in PDF, provision is made for the content of each of the pages of the sheet to be provided in the form of an XObject form, known per se, in such a way that, for possible editing and/or replacement of a page, the respective page from the XObject form is produced from the sheet PDF and a new XObject form is then produced for the changed replaced page and inserted into the sheet PDF as a replacement for the earlier XObject form. For the production of at least one page from an XObject form, a new PDF page is preferably produced for this form defined in the sheet.

For each form defined in the sheet, a new PDF page of the size of the BoundingBox form (corresponding to the size of the original page) is produced. In particular, all form source elements and the form content description are copied into the appropriate elements in the PDF page. The pages produced in this way are preferably appended to the end of the sheet PDF. In relation to each new page produced, the reference to the associated original form is stored.

The next development provides for the sheet pages of the sheet PDF to be removed temporarily from the PDF that can be viewed on the monitor, but to remain stored. Following this step, a “normal” multi-page PDF document is present. The transformation located outside the form in the sheet page and an existing clip are no longer effective. All the pages therefore correspond in size and orientation to the original. The removal of the sheet pages is not absolutely necessary but leads to improved clarity.

If, as is preferably provided, all the new PDF pages produced are made available together as a multi-page PDF document, this advantageously permits the utilization of all the tools which are normally available from various providers, in particular for changing page contents. These tools do not function in the original sheet document or function only to a restricted extent. Instead of changing individual pages manually, according to the invention even entire pages can be replaced by pages from other documents.

Following the changes, the sheet PDF is produced again. For the changed pages, finally a new XObject form is produced in each case and replaced in the internally stored copy of the original sheet resource. For this purpose, the page content description and page resources are copied into the new form in an appropriate manner. The appended individual pages are removed and the internal page copies are inserted again. Since only the XObject forms are replaced but not the transformation or clipping acting in the page description, the original layout of the sheet is maintained. Changed pages should substantially maintain the page format in order that a practical result is produced.

The method according to the invention can be applied as often as desired to a sheet in PDF.

Independent protection is also claimed for a sheet provided in a data storage medium, preferably in a data storage medium implemented in a data-processing device, in particular for the creation of a print. The sheet contains a plurality of pages (content pages), preferably following an imposition scheme, and, according to the invention, in a self-contained solution to the object set, is distinguished by the fact that the content of each of the pages of the sheet is available in such a way that, in relation to a possible change and/or replacement of a page, a changed or replaced page can be inserted into the sheet as a replacement.

The sheet is preferably provided in what is known as a “Portable Document Format” (PDF), in particular for the creation of a print, and, according to a development of the invention, is distinguished by the fact that the content of each of the pages of the sheet is provided in the form of an XObject form, known per se, in such a way that, for the purpose of possible editing and/or replacement of a page, the respective page from the XObject form can be produced from the sheet PDF and then, for the changed or replaced page, a new XObject form can be produced and inserted into the sheet in PDF as a replacement for the earlier XObject form.

The advantages associated with this have already been explained and discussed with the same effect in connection with the method according to the invention.

Other features which are considered as characteristic for the invention are set forth in the appended claims.

Although the invention is illustrated and described herein as embodied in a method for providing data for a sheet, in particular for creating a print, and a sheet provided thereby, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is an illustration of a front side of a printed sheet which has eight pages which are disposed in accordance with an imposition scheme according to the invention;

FIG. 1B is an illustration of a reverse side of the printed sheet according to FIG. 1A;

FIG. 2A is an illustration of pages removed for editing from the front side of the printed sheet according to FIG. 1A;

FIG. 2B is an illustration showing the pages according to FIG. 2A with a changed page;

FIG. 3A is an illustration showing the front side according to FIG. 1A with the inserted changed page from FIG. 2B; and

FIG. 3B is an illustration showing the unchanged reverse side according to FIG. 1B.

### DESCRIPTION OF THE PREFERRED EMBODIMENTS

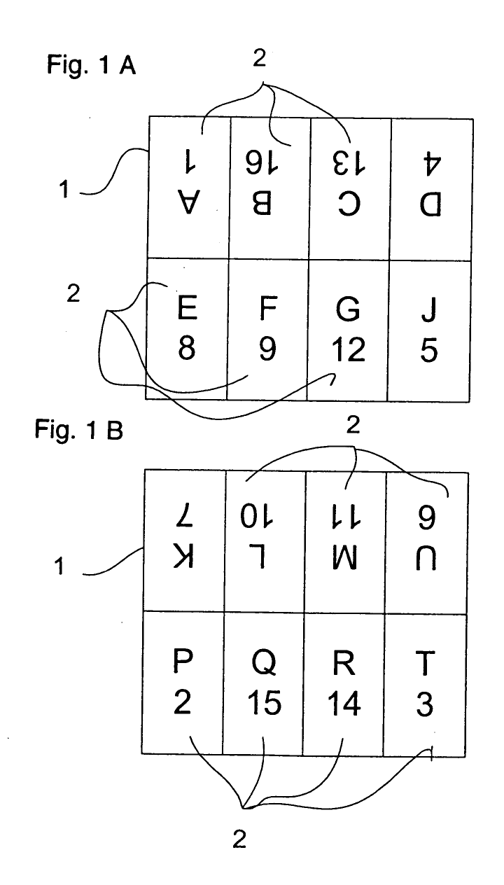

Referring now to the figures of the drawing in detail and first, particularly, to FIGS. 1A and 1B thereof, there is shown a front side and a reverse side of a printed sheet 1 which contains a plurality of pages 2, namely a total of sixteen consecutively numbered pages A, B, C, D, E, F, G, J, K, L, M, U, P, Q, R, T, which are disposed in accordance with an imposition scheme, so that, following appropriate folding of the sheet, they exhibit a sequence of the sixteen pages which can be stapled, following the numbering progressively, that is to say A 1, P 2, T 3, D 4, J 5, U 6, K 7, E 8, F 9, L 10, M 11, G 12, C 13, R 14, Q 15 and B 16. The letters used have been chosen in such a way that their orientation can be detected unambiguously. In this case, the letters stand for any desired but in each case unambiguously selected text, graphics, logos or combinations thereof.

If such a sheet is provided in the PDF format, then the layout for each original content page 2 specifies the exact position via an affine transformation on the sheet 1. Additional clip parts, normally rectangles, can additionally intersect the content pages. If a sheet in PDF is calculated by imposition software, then the result obtained is a normally multi-page in PDF, in which on each page either a sheet front side or a sheet reverse side (for recto and verso printing) has been produced in complete form, as indicated in FIGS. 1A and 1B. Depending on position and transformation, individual pages 2 are, for example, upright or upside down.

Now, there are XObject forms that are known per se and used in a specific way in the present invention in order, so to speak, to encapsulate any desired contents as a content element that is self-contained and independent of the rest of the page. A PDF XObject form describes the contents with the commands defined in the PDF (graphics, text, image, . . . ). All the resources needed for this, such as texts or images, are defined within the XObject form. If, according to the invention, each original page is present in the sheet in PDF as a separate XObject form, it is therefore possible for a subsequent correction to the content data to be made possible by the method according to the invention.

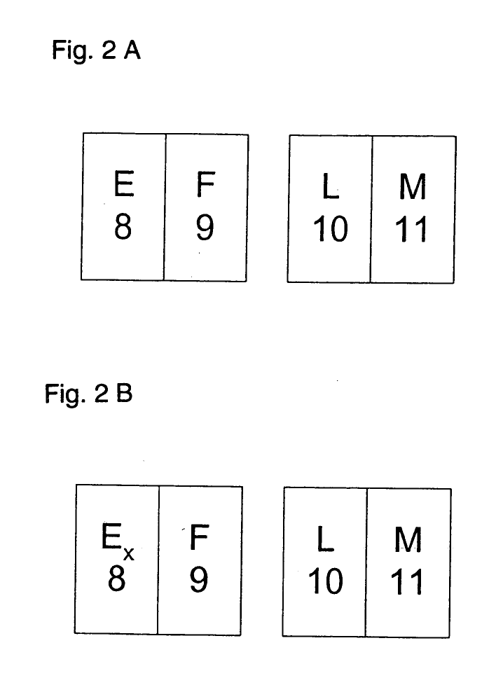

For this purpose, page 2 from the sheet, as shown by way of example in FIGS. 2A and 2B and described further above in relation to the method according to the invention, is provided for a change. In the example shown, the page “E 8” from FIG. 2A is revised to form a page “Eₓ 8” or replaced by such a page in FIG. 2B.

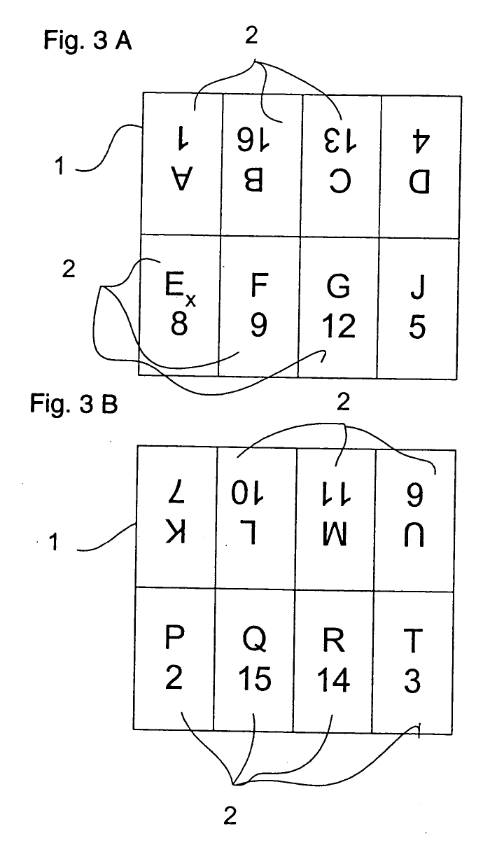

After that, as shown in FIG. 3A, the changed page “Eₓ8” is inserted into the sheet 1 instead of the page “E 8”. As can be seen in FIG. 3B, the reverse side of the sheet 1 remains untouched and unchanged by this exemplary change in this case shown.

1. A method for providing data for a sheet containing at least two pages within a workflow, which comprises the steps of:
providing and using a data-processing device containing at least one data storage device, a data input device and a monitor; and
providing each of the pages such that each of the pages can be edited.

2. The method according to claim 1, which further comprises:
providing a content of each of the pages of the sheet such that, in relation to a possible change and/or replacement of a respective page, the respective page is provided and a changed or replaced page is then inserted into the sheet as a replacement.

3. The method according to claim 2, which further comprises:
providing the sheet in a portable document format (PDF);
providing the content of each of the pages of the sheet in a form of an XObject form;
producing a new XObject form for a changed or replaced page; and
inserting the new XObject form into the sheet in the PDF as a replacement for the XObject form of the changed or replaced page.

4. The method according to claim 3, which further comprises for producing at least one page from the XObject form, producing a new PDF page for the XObject form defined in the sheet.

5. The method according to claim 4, which further comprises appending the new PDF page to an end of the sheet in the PDF.

6. The method according to claim 4, which further comprises copying all source elements and all content elements of the XOBject form into appropriate elements of the new PDF page.

7. The method according to claim 4, wherein in relation to the new PDF page produced, a reference to an associated original page is stored internally.

8. The method according to claim 1, which further comprises removing pages of the sheet in the PDF temporarily from the PDF that is visible on the monitor but remain stored.

9. The method according to claim 4, wherein all new PDF pages produced are made available together as a multi-page PDF document.

10. The method according to claim 5, which further comprises following the insertion of the new XObject form into the sheet in the PDF, an appended PDF page is removed again.

11. The method according to claim 1, which further comprises forming the pages as content pages.

12. The method according to claim 1, which further comprises forming the sheet as a printed sheet.

13. A sheet provided in a data storage medium, comprising:
a plurality of pages (content pages) following an imposition scheme, a content of each of said pages of the sheet is provided such that, in relation to a possible change and/or replacement of a page, a changed or replaced page can be inserted into the sheet as a replacement.

14. The sheet according to claim 13, wherein the sheet is provided in a portable document format (PDF), and said content of each of said pages of the sheet is provided in an XObject form, such that, in relation to the possible change and/or replacement of the page, a new XObject form is produced for the changed or replaced page and the new XObject form is inserted into the sheet in the PDF as a replacement for the XObject form.

15. The sheet according to claim 13, wherein the data storage medium is implemented in a data-processing device and the sheet is created as a printed sheet.
